(19) United States
(12) Patent Application Publication
(10) Pub. No.: US 2010/0030710 A1
(43) Pub. Date: Feb. 4, 2010

(54) REAL TIME, IN-PERSON SOCIAL NETWORKING

(76) Inventor: Jeffrey L. PULVER, Great Neck, NY (US)

Correspondence Address: PILLSBURY WINTHROP SHAW PITTMAN, LLP, P.O. BOX 10500, MCLEAN, VA, 22102, US

(21) Appl. No.: 12/492,007

(22) Filed: Jun. 25, 2009

Related U.S. Application Data
(60) Provisional application No. 61/075,617, filed on Jun. 25, 2008.

(51) Int. Cl. G06Q 90/00; B42D 15/00; G09F 3/10

(52) U.S. Cl. 705/500; 283/70; 40/299.01; 40/638

(57) ABSTRACT

Systems and methods of the invention for providing real-time, in-person social networking provide a plurality of instructions to individuals in a group as well as a setting and time for the group to carryout the instructions. A networking kit may be provided to each individual in the group. The instructions may further comprise having each individual in the group write his or her name and a personal characteristic on labels from the kit, having each individual place a first label and a second label on a visible and accessible portion of his or her clothes, and having each individual greet another individual in the group and write clauses or sentences of about another individual greeted during the function. This networking style may continue for a predetermined time until the group convenes to discuss their observations and insights.

### CROSS-REFERENCE TO RELATED APPLICATIONS

This application claims priority to U.S. Provisional Application No. 61/075,617, filed Jun. 25, 2008, the contents of which are hereby incorporated by reference herein in their entirety.

### FIELD OF THE INVENTION

Implementations of the invention are directed to real-time, in-person social networking techniques. More specifically, implementations of the invention may include systems, methods, and devices for promoting, enhancing or otherwise supplementing the in-person social networking activities of an individual, organization, or group in real-time.

### BACKGROUND

Companies and individuals regularly organize and participate in meetings or gatherings for various reasons, including social interaction, social expression, and information gathering and exchange. When these gatherings are performed in rigid or otherwise unfriendly settings, participants in the gathering may feel suppressed during the gathering such that the company or other organization conducting the gathering may not accomplish one or more of its goals. In some instances, the rigid or unfriendly atmosphere of the meeting may be promoted by a formal setting, by an errant perception of arrogance amongst the participants, by shyness of the participants, and by other reasons as well. When participants attend a meeting but have little if any interaction or if the interactions and communications are trivial or superficial, the meeting is unlikely to accomplish its intended purpose and participants are unlikely to learn much if anything from the meeting. Time is not well spent. The resources expended to convene and hold the meeting are not well spent.

Still further, when communication is not carried out effectively during the meeting, participants may receive misinformation about the purpose of the meeting and the people they meet and greet. Even though a participant is a skilled artisan or professional, this information may never be relayed to others or others may not perceive a person as having these traits. When this occurs, the conversation and the communications are not effective, they can be considered as an inefficient use of time, and may even be perceived as having negative effects when wrong information is conveyed or understood, This lack of exchange of relevant communications or incorrect communications can affect the willingness of participants to engage in future group or networking activities and may affect the manner in which an organization chooses to build teams within it and exchange information throughout the organization.

### SUMMARY OF THE INVENTION

Implementations of the invention include systems, methods, and devices for real-time, in-person social networking. In some implementations, the invention may include providing a plurality of instructions to individuals in a group and then providing a setting and time for the group to carryout the instructions. In some implementations, the invention may include providing networking kits to a group comprised of individuals, where the networking kits may include a writing instrument, one or more labels, one or more tags, and one or more notes. The instructions may further include having each individual in the group write his or her name and a personal characteristic on labels from the kit, having each individual place a first label and a second label on a visible and accessible portion of his or her clothes, and having each individual greet, interact with, and/or observe other individuals in the group and write clauses of about ten or less words on a tag about the other individuals interacted with or observed during the function. These tags may then be placed on the second label of the individual for which the written clauses apply. The instructions may further include having individuals write sentences regarding one or more other individuals interacted with or observed during the function on notes. These notes may then be placed in an area associated with the individual about which the note is written. This networking style may continue for a predetermined time until the group may convene to discuss their observations and insights as reflected in or assisted by the tags and/or notes.

These and other objects, features, and advantages of the invention will be apparent through the detailed description and the drawings attached hereto. It is also to be understood that both the foregoing summary and the following detailed description are exemplary and not restrictive of the scope of the invention.

### BRIEF DESCRIPTION OF THE DRAWINGS

FIG. 1 is a flow diagram which illustrates a method for performing real-time, in person, social networking according to various implementations of the invention.

FIG. 2 illustrates a kit for performing real-time, in person, social networking according to various implementations of the invention.

FIG. 3 illustrates an example of a shirt of a participant in a networking function, according to various embodiments of the invention.

FIG. 4 illustrates a computer implemented system for facilitating real-time, in-person, social networking according to various embodiments of the invention.

### DETAILED DESCRIPTION

A person's and an organization's ability to express themselves, communicate, and learn from each other is an important characteristic of thriving and effective people, groups, and organizations. When done effectively, real-time and ongoing expression and communication can provide individuals in a group, and an organization as a whole, the benefit of the collective knowledge and experiences of the individual members. Individuals may learn of other's expertise and strengths and can share his or her strengths and experiences with others and, by default, the group or organization. Existing needs may be filled and people can be given the opportunity to carry out tasks and have responsibilities in areas in which they have expertise and in which they enjoy working, but may otherwise may not have access to. When individuals and groups don't share their experiences and knowledge properly, productivity and effectiveness may suffer. Individuals may not feel satisfied in their roles and the work they perform. Organizations and groups may lag behind their peers or may not achieve the performance they are capable of, despite the expertise of the members of the group.

Ineffective expression and communication can be promoted by a lack of understanding or teaching of best social networking practices, because of natural personality traits, such as shyness, because an organization does not effectively promote itself and for various other reasons.

The invention provides systems, methods, and devices to promote and enhance personal networking functions and the skills of those engaging in the networking function or activity. For example, in some implementations, methods may be used that promote clear and concise communication and the easy flow of information during face-to-face conversations. These methods may also include steps for providing timely feedback to individuals on the effectiveness of their communications and other's perception of them. In some implementations, systems and devices may include networking kits containing removable labels, notes and tags, writing instruments, a posting wall or surface, and instructions explaining how to carryout and execute the networking function or activity.

In some implementations, a group of people may gather to participate in a networking function of some kind (e.g., breakfast, lunch, dinner, etc.). The members of this group may receive instructions on how members of the group may greet, interact or otherwise communicate with each other. The members of the group—“the participants”—may receive a social networking packet or kit that includes the instructions (although these may be provided separately), a pen or other writing instrument, a plurality of labels, a plurality of tags, a plurality of note papers and/or other items. In some instances, the labels, the tags, and/or the note papers, may have an adhesive backed attachment surface so as to affix these items to the cloths of participants or to other surfaces. In some instances, other methods/components may be used to affix these items to surfaces (e.g., safety pins, loop and/or hook systems [e.g., Velcro™], or other fixation methods/components). In one example, labels sold under the Avery™ tradename, pens sold under the Bic™ tradename, and tags and/or note papers sold under the Post-it™ tradename may be used.

In some implementations, the instructions provided to the participants may include instructions for each participant to write his or her name and a personal “tagline” on a first label of the plurality of labels and to use a second label of the plurality of labels as a “personal tag cloud” or area where tags containing phrases about the person may be placed. Each of the first and second labels may then be stuck/affixed to the clothes of the participant. In some instances, the personal tagline may be a pithy saying or characterization/characteristic about the participant on whom the first and second labels are to be affixed or other portion of text regarding the participant on whom the first and second labels are to be affixed. Examples of these taglines may include: “travel for breakfast;” “taking fun seriously;” “making fun happen;” “I protect inventor's ideas;” and/or other phrases/portions of text.

The instructions may further include instructions to have each of the participants place “social tags” on each other as they speak, listen or otherwise interact. These social tags may include the tags of the kit having writing (e.g., phrases of ten words or less or other writing) thereupon and may be placed on or about the “personal tag cloud” of the second label. The writing on the social tags may include a limited number of words written by a listener that describe the speaker. Examples of lines that can be written on the social tags include: “blogger;” “photographer;” “dad;” “amazing;” and/or other words or phrases. In some implementations, tags may be sized in relation to the labels such that multiple tags may be placed in a label serving as a personal tag cloud of a given participant.

The instructions may also include instructions to have each of the participants write other comments (e.g., sentences of 5 words or more) about the participants or themselves on the adhesive-backed note paper and place the paper containing these comments on the applicable person, on themselves, or a posting wall (e.g., a bulletin board) or other surface designated for the particular person. The networking function may continue as the participants interact with each other, applying the instructions they have received as a guide for their communications. In some implementations, notes may differ from tags in that they need not be sized to fit on a label along with other items, but may be larger enough so as to provide a writing surface on which to write sentences (rather than phrases).

During the networking function, following these instructions, participants may verbally and/or non-verbally great each other and discuss topics or points of interest. During the discussion any one or more of the participants may create a note or tag about another person or themselves and place the note or tag on the other person or a space designated for the other person. A note (e.g., written on an adhesive-backed note paper) may include a sentence regarding the writer's perception about the person, may include a similar experience that the writer has had, may include the name of a friend with whom the writer is reminded of, and/or may include other information. Comparatively, a tag (e.g., written on one of the one or more tags provided with the kit) may include a short synopsis or short observation about the person. The note may be placed on the person's clothes or a surface (e.g., wall, bulletin board) designated for the person. The tag may be placed on or about the personal tag cloud label on the clothes of the person but in some implementations, may be placed elsewhere (e.g., a posting wall).

In some implementations, certain participants may be designated as speakers while other participants may be designated as listeners. The participants in the networking event may be grouped into one or more groups (e.g., a large group having one or more speakers and one or more listeners or multiple groups, each having one or more speakers and one or more listeners). The listeners may then be instructed to write on one or more tags having descriptive phrases relating to one or more speakers in their group describing the listener's perception of the speaker. In some embodiments, the listeners may then be instructed to place the one or more tags having phrases relating to a particular speaking individual into an area associated with the particular speaking individual such as, for example, a personal tag cloud on a label associated with the speaker. In some implementations, the area where the one or more tags are placed may be an area on the speaker's clothes out of the sight of the speaker. In some implementations, one or more notes having writing relating to the speaker may also be written by listeners and placed in an area associated with the speaker (e.g., on the speakers clothes, on a personal wall, etc.). In some embodiments, the designation of speaker and listener may only last for a portion of time during the networking event and new speaker and listener designations may be made after that time period is over or after the speaker has finished speaking.

In some implementations, speakers and listeners need not be designated, but groups of participants may carry on conversations in which participants shift speaking and listening roles dynamically as the conversation proceeds. In some implementations, groups of individuals need not be specifically designated, but participants may be allowed to form groups in a free-form manner.

In some instances, participants in a given conversation may review the notes and tags being posted on themselves or other participants and may reflect or comment on those notes and tags by placing additional notes and tags on themselves or others. Before, during or after a conversation, participants may also write identical notes or different notes and place these notes on a wall associated with a speaker or clothes surface of a speaker associated with the comments on the note. In some implementations, a surface on a posting wall (e.g., bulletin board, white board, or other surface) for posting notes regarding participants may be partitioned with areas designated for each of the participants in the networking/function. In some implementations, one or more partitions/areas may exist for individuals who are not participating in the network function. In addition, participants in the networking session may also add areas for other names to the posting wall or other surface. This may include the names of people personally known by the participants, the names of people not personally known by the participants (such as public figures or friends of friends), and/or the names of other categories of individuals.

In some implementations, session participants may post notes on the posting wall during the networking session as they see fit. This may include sharing information about others in a person's designated area and sharing information about themselves in the area designated for themselves or designated for others. They may place this information about themselves in both areas as well.

Upon reading notes or other information on the posting wall, a participant's clothes, or other surface, and/or upon reading tags on other participants, participants may write more tags or more notes for posting. Drafting, posting, and review may continue for a portion or all of the networking meeting. It may proceed for a predetermined portion of the meeting, (e.g., an hour of a two-hour gathering). Other time periods are also possible.

In some embodiments, a portion of the networking event may be held open for a group discussion of the observations of the participants. This discussion may be led by a participant, a designated emcee, an observer, an administrator, and/or other person. In some implementations, during the group discussion, participants may be instructed/asked to explain information they learned about themselves from the notes or tags on themselves, on others, and/or on a posting wall. In some implementations, participants may also be instructed, asked or otherwise prompted to explain information they learned about others in the group from notes or tags.

In some instances, performing real-time, in-person, social networking in this fashion may enable shy or otherwise less outgoing or approachable individuals to socially interact more freely than they otherwise would. Social “walls” may be broken down between members of the group. In so doing, more information may be exchanged between participants. The information being relevant to the group and the participants and being weighted or vetted out by the frequency in which certain observations or statements were made. In other words, if the same or a similar observation was made about an individual, that observation may be taken as an objective observation of the individual from the group. Conversely, if only one or a few like observations are made about an individual, this observation is less likely to be an objective one and is more likely to be a subjective one from individual members of the group and not the group as a whole. Having the benefits of this weighting system or vetting system, the participant can gauge the effectiveness of his or her communications and how others are perceiving him or her.

In some implementations, at the conclusion of the meeting, the sponsor may gather the notes and record where they were posted and then distribute this information to participants in the group and the group as a whole.

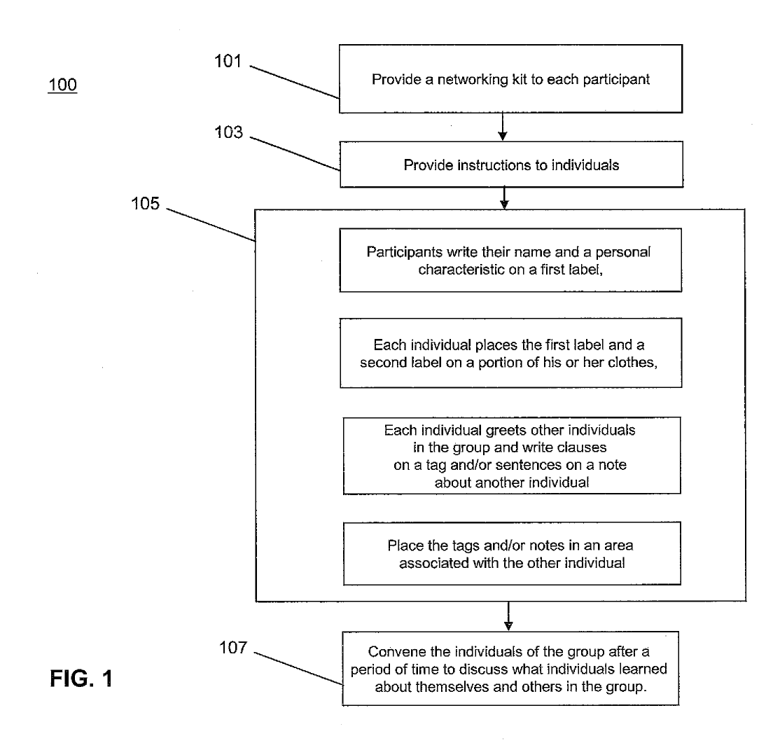

FIG. 1 illustrates a process 100, which is an example of a process for performing real-time, in-person, social networking, according to various implementations of the invention. FIG. 1 illustrates operations that may be performed in the order shown as well as in different orders and with more or fewer operations. Process 100 includes an operation 101, wherein, a networking kit is provided to each individual participant in a group participating in a networking event. In an operation 103, instructions regarding how to use the contents of the networking kit are provided to the participants of the group during the networking event. In some implementations, the instructions may be included as part of the kit or may be provided to participants prior to providing the participants with the kits and/or prior to the networking event. Providing the instruction may include providing written materials on which the instructions are written, displaying/playing an audio and/or video presentation, reading (e.g., by an administrator or emcee) instructions to the participants, and/or other methods. In an operation 105, one or more of the participants utilize the items (e.g., labels, tags, adhesive-backed notes) in their networking kit according to the instructions during a communication and/or information exchange portion of the networking event (which may be a predetermined or specific time period designated for such interaction). Utilizing the items of the kit according to the instructions may include participants writing their names and personal traits or characteristics on labels, placing these labels for the review of others (e.g., on their clothes), speaking and listening to each other, and commenting on what is spoken and heard through the use of tags and notes. After a period of time for communication and/or information exchange has passed, the group may convene to discuss individual findings and observations in an operation 107.

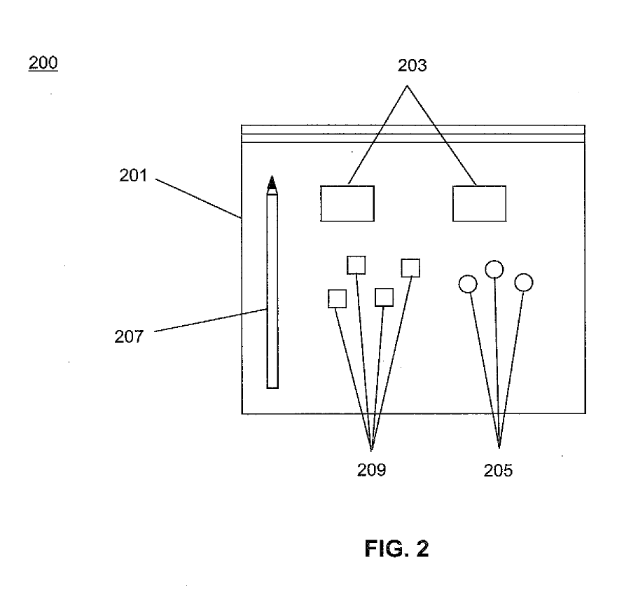

FIG. 2 illustrates a networking kit 200 that may used in as part of a system for real-time, in-person, social networking according to various implementations of the invention. Kit 200 may include bag 201 (e.g., a clear plastic re-sealable bag or other bag), one or more labels 203, one or more tags 205, a writing instrument 207 (e.g., a pen, a pencil, a marker, or other writing instrument), one or more notes 209 (e.g., adhesive-backed note papers), and/or other items. In some implementations, each of labels 203, tags 205, and notes 209 may have a writing surface on one side and may be attachable to a surface (e.g., via an adhesive surface or Velcro-type implement [e.g., hooks and/or loops] on an attachment surface on a side opposite to the writing surface). In some implementations, labels 203, tags 205, and/or notes 209 may also be selectively treated to adhere/attach to select portions of kit 200 or specific surfaces but not to other surfaces. For example, tags 205 may be treated to adhere to a front surface of labels 203 but not to other surfaces. In this way the tags can only be placed on the labels. In some implementations, the front surface of a label 203 may be treated with a certain substance or include certain features such that when a tag is placed thereon, the tag adheres thereto, but wherein the tag will otherwise not adhere to a surface not treated with the certain substance or including the certain features (e.g., the label may include a hook type Velcro surface while the attachment portion of the note may include the corresponding loop-type Velcro surface).

In some implementations, kit 200 may include a first kind of label 203 having a front surface adapted to be written on using, for example, writing instrument 207 such as, for example, a flat surface that absorbs or readily accepts ink or pencil lead. In some implementations, kit 200 may include a second kind of label 203 that serves as a personal tag cloud and that has a front surface adapted to accept one or more tags 205 (e.g., a “rough surface” that enables accepts adhesive from the tag to adhere to the front surface of the second kind of label 203; a hook surface corresponding to a loop surface [or vice versa] of a tag). In some implementations, labels 203 may be adhesive-backed labels such as, for example, those manufactured by Avery, Inc. In some implementations, all labels 203 may be, at least initially, identical.

In some implementations bag 201 may be a sandwich bag or similar clear plastic bag with zipper top, may be a larger clear plastic bag, and/or may have a different type of sealing top. In some implementations, paper bags or other bags may also be used. In some implementations, tags 203 and notes 209 may be Post-It™ brand adhesive note products. In each case, other brands and products may be used.

In some implementations, kit 200 may be handed out at the onset of the networking event. In some implementations, kit 200 may be mailed or otherwise sent to participants prior to the beginning of the networking event. In some implementations, time may be spent at the beginning of the networking event assembling kits. In some implementations, rather than providing individual kits, larger kits may be provided where multiple pens, tags, labels, and notes for several people. This larger “group kit” or assembling kits at the beginning of the networking event is that the assembly and distribution process promotes interaction and “ice-breaking” between participants, which can serve as a catalyst for carrying out the other steps of the in-person networking process and method described herein.

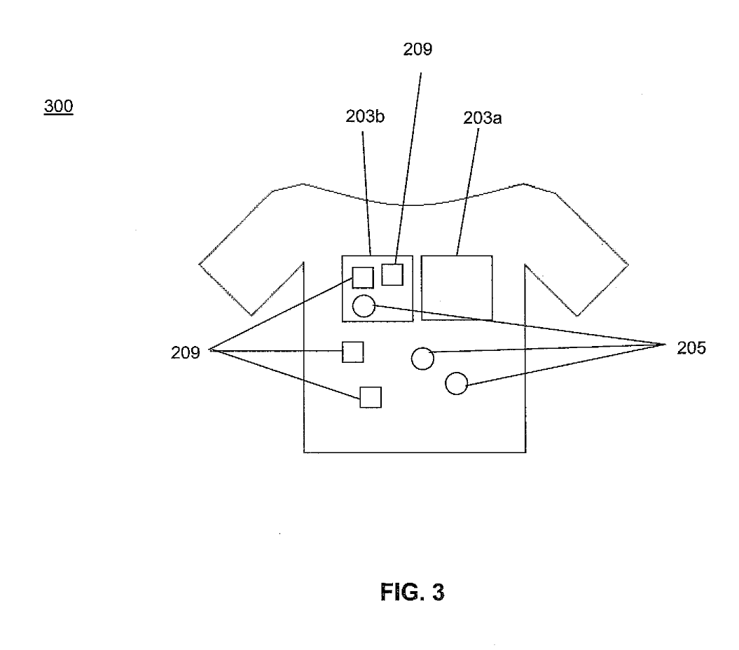

FIG. 3 illustrates a shirt 300 of a participant in the in-person real-time networking event having various items thereupon according to various implementations of the invention. As illustrated, two labels 203a and 203b have been placed on the front of shirt 300. Label 203a may include the name and personal tag line of the participant while label 203b may serve as the personal tag cloud, where tags and notes may be placed. As illustrated, both notes 205 and tags 209 have been placed on label 203b during the networking function. As also illustrated, notes 205 and tags 209 have also been placed outside of the personal tag cloud. This informal placing may be indicative of a successful networking function as it may show that participants were relaxed around each other and may not have been restricted by traditional rigid social boundaries or “walls,” during their conversations.

The relaxed exchange can promote efficient and substantial exchanges of information. Indeed, labels 203, notes 209, and tags 205 maybe placed elsewhere on the person of each participant. For example, labels 203 may be placed on the front of the shirt 300, while notes 209 may be placed on the back of the shirt so that the participant may not see the notes until the end of the social networking function but others participating in the event may see the notes during the function. If notes are placed on the back of a participant, the participant may also wait until half-way or other portion through the function to read these notes and then may chose to act on the notes read in this fashion. Instructions provided to the networking group at the beginning of the function may explain that the labels, notes, and tags need not be placed on the front of participants clothes and that participants may chose to have the notes, tags, and labels, unavailable to him or her for some or all of the in-person networking event.

The clothes worn by the participants may have adhesive areas specially treated to allow notes, tags, or labels to remain on the clothes during the network function, but then be easily removed after the networking function. This removal may be done without damaging the clothes, damaging the notes, tags, or labels and without rendering their attachment portions useless through the transfer of fabric threads or otherwise. The clothes may be handed out or otherwise distributed ahead of the meeting, at the beginning of the meeting, or during the meeting. Examples of special treatment of clothes may include the use of Velcro, reusable adhesive-based systems, and/or other systems.

In some implementations, the invention may include a computer-implemented system for facilitating real-time, in-person social networking. The computer implemented system may include one or more computing devices having one or more processors that are configured to provide the instructions regarding how to utilize/use one or more networking kits for real-time, in-person social networking. In some implementations, the instructions may be provided to participants in a networking event via an audio/video presentation running on or otherwise enabled by the computer-implemented system and presented to one or more participants (and/or one or more emcees or administrators) via a one or more display screens. In some implementations, the instructions may be provided to participants (and/or emcees or administrators) via text (e.g., as a printout from a printer, displayed on a display screen of a common display device or the display screens of devices associated with one or more individual participants).

In some implementations, the one or more processors of the computer-implemented system may be configured to enable electronic versions of one or more of the labels, tags, and/or notes described herein. For example, a listening participant may write a tag or a note regarding a speaker on a computer-implemented device (e.g., a handheld computer, laptop, smartphone) and virtually, place that tag or note on a virtual area associated with the speaker via the computer-implemented device.

In some implementations, the one or more processors of the computer implemented system may be configured to receive data regarding various labels, tags, and/or notes and any information thereon and/or participants associated therewith. This data may then be sorted, filtered, and/or categorized (e.g., by participant, by author, etc.) and/or displayed by the computer implemented system in any number of different ways that facilitate discussion or interaction among participants.

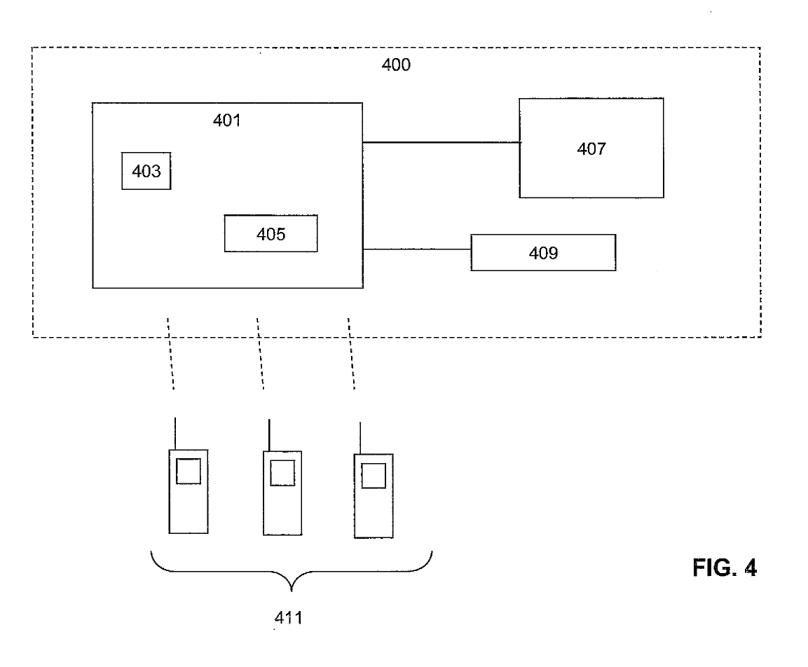

FIG. 4 illustrates a system 400, which is an example of a computer-implemented system for performing real-time, in-person social networking. System 400 may include at least one computing device 401 having at least one processor 403. Computing device 401 may also include memory 405 storing computer-executable instructions (e.g., an application and/or one or more modules) for performing one or more of the features and functions described herein. System 400 may also include one or more display devices 407 (e.g., a computer monitor or TV screen) and one or more input devices 409 (e.g., a keyboard, mouse and/or other input devices). System 400 may include and/or interact with/receive and/or send information to/from one or more computing devices 411 (e.g., handheld computing devices, laptop computers, smart phones, etc.), which may be associated with one or more participants in the networking event. The configuration illustrated in FIG. 4 is an example configuration. Other configurations, including those having more, less, or different components, may be used as would be appreciated.

In some implementations, the invention includes a tangible computer-readable media (e.g., CD-ROM, hard disk, non-volatile memory, or other media) having computer executable instructions thereupon for configuring one or more processors to perform some or all of the features and functions of a computer-implemented system for facilitating real-time, in-person social networking described herein.

Various embodiments have been provided herein. The invention is not to be limited to these embodiments and should be considered to include all of the various teachings of the application, including the specification, claims, and drawings. Other embodiments are also plausible, including performing some or more of the steps identified herein and performing these steps in the order identified as well as in different orders and with more or fewer steps. Likewise, kits, systems, and devices embodying the invention may include additional components, such as additional adhesives, glues, pins, clips, pens, markers, and other devices. Thus, the claims should not be limited by particular embodiments described herein, but should instead be read to include other embodiments and equivalents thereof.

What is claimed is:

1. A method of in-person social networking for a plurality of individuals using a plurality of networking kits, the method comprising:
providing each individual of the plurality of individuals with a networking kit from the plurality of networking kits, wherein the networking kits include one or more labels having a writing surface thereon, one or more tags having a writing surface thereon, and one or more notes having a writing surface thereon;
providing instructions to each individual of the plurality of individuals to write his or her name and a personal characteristic on a first label of the one or more labels;
providing instructions to each individual of the plurality of individuals to place the first label on a visible and accessible portion of his or her clothes;
providing instructions to each individual of the plurality of individuals interact with one or more other individuals from the plurality of individuals during a specific time period for interaction;
providing instructions to each individual of the plurality of individuals to write a phrase on a tag of the one or more tags, the phrase relating to another individual of the plurality of individuals interacted with during the specific time period for interaction;
providing instructions to each individual of the plurality of individuals to write one or more sentences on a note, the one or more sentences relating to another individual of the plurality of individuals interacted with during the specific time period for interaction; and
convening the plurality of individuals together after the specific period of time to discuss what individuals learned about themselves and others in the plurality of individuals.

2. The method of claim 1, wherein convening the plurality of individuals together further comprises:
collecting the labels, tags, and notes;
generating a record of the labels, tags, and notes; and
distributing the record of the labels, tags, and notes to one or more of the individuals in the plurality of individuals.

3. The method of claim 1, wherein the plurality of networking kits originate from a larger kit of labels, tags, and notes for the plurality of individuals in the group.

4. The method of claims 3, wherein providing each individual of the plurality of individuals with a networking kit further comprises assembling the plurality of networking kits from the larger kit in the presence of the plurality of individuals.

5. The method of claim 3, wherein providing each individual of the plurality of individuals with a networking kit further comprises providing instructions for individuals of the plurality of individuals to assemble in sub-groups that share the labels, tags, and notes from one or more of the plurality of networking kits.

6. The method of claim 1, wherein providing instructions to each individual of the plurality of individuals to place the first label on a visible and accessible portion of his or her clothes further comprises providing instructions to each individual of the plurality of individuals to place a second label from the one or more labels on a visible and accessible portion of his or her clothes, and wherein providing instructions to each individual of the plurality of individuals to write a phrase on a tag of the one or more tags further comprises providing instructions to place each tag on the second label of each of the individual from the plurality of individuals about which the phrase relates.

7. The method of claim 1, wherein providing instructions to each individual of the plurality of individuals to write one or more sentences on a note further comprises providing instructions to place one or more of the tags on which a phase is written or a note on which one or more sentences are written onto an area associated with an individual from the plurality of individuals about which the phrase or sentences are written.

8. The method of claim 7, wherein the area is the clothes of the individual about which the phrase or sentences are written.

9. The method of claim 7, wherein the area is an area not on the not on the person of the individual about which the phrase or sentences are written.

10. The method of claim 9, wherein the area is a portion of a posting wall specifically designated for the individual about which the phrase or sentences are written.

11. The method of claim 1, wherein providing each individual of the plurality of individuals with a networking kit further comprises providing an article of clothing to each individual of the plurality of individuals, the article of clothing having an area designated and previously treated for adhering to the one or more labels.

12. The method of claim 1, all instructions are provided in written form in each of the plurality of networking kits.

13. The method of claim 1, wherein providing instructions to each individual of the plurality of individuals interact with one or more other individuals from the plurality of individuals further comprises designating one or more of the plurality of individuals as speaking individuals and one or more individuals of the plurality of individuals as listening individuals, wherein providing instructions to each individual of the plurality of individuals to write a phrase on a tag of the one or more tags further comprises:
providing instructions to each listening individual to write on one or more tags descriptive phrases relating to a speaking individual that describe the listening individual's perception of the speaking individual; and
providing instructions to each listening individual to place the one or more tags having phrases relating to a particular speaking individual into an area associated with the particular speaking individual.

14. The method of claim 8, wherein the area associated with the particular speaking individual is an area of the particular speaking individual's clothes outside of the sight of the particular speaking individual.

15. The method of claim 8, wherein the area associated with the particular speaking individual is an area not on the person of the particular speaking individual.

16. A system for in-person social networking for a plurality of individuals, comprising:
a plurality of networking kits, each networking kit including:
one or more labels having a writing surface and an attachment surface,
one or more tags having a writing surface and an attachment surface, and
one or more notes having a writing surface and an attachment surface; and
a set of instructions embodied in a tangible medium, the instructions including:
instructions to each individual of the plurality of individuals to write his or her name and a personal characteristic on the writing surface of a first label of the one or more labels of their respective kit,
instructions to each individual of the plurality of individuals to place the first label on a visible and accessible portion of his or her clothes,
instructions to each individual of the plurality of individuals interact with one or more other individuals from the plurality of individuals during a specific time period for interaction,
instructions to each individual of the plurality of individuals to write a phrase on the writing surface of a tag of the one or more tags, the phrase relating to another individual of the plurality of individuals interacted with during the specific time period for interaction,
instructions to each individual of the plurality of individuals to write one or more sentences on the writing surface of a note from the one or more notes, the one or more sentences relating to another individual of the plurality of individuals interacted with during the specific time period for interaction, and
instructions to convene the plurality of individuals together after the specific period of time to discuss what individuals learned about themselves and others in the plurality of individuals.

17. The system of claim 16, wherein the attachment surfaces of one or more of the one or more labels, one or more tags, or one or more notes are attachable to clothes of one or more of the plurality of individuals.

18. The system of claim 16, wherein the attachment surfaces of one or more of the one or more labels, one or more tags, or one or more notes include adhesive.

19. The system of claim 16, wherein each kit from the plurality of networking kits further includes one or more tag cloud labels, the one or more tag cloud labels including a tag adhering surface and an attachment surface, wherein the tag adhering surface enables the one or more tags to be attached thereto via the attachment surface of the one or more tags and wherein the attachment surface of the one or more tags is not suitable to be attached to surfaces other than the tag adhering surface.

20. The system of claim 19, wherein the one or more tag cloud labels and the one or more labels are identical.

21. The system of claim 16, wherein each kit from the plurality of networking kits further includes an article of clothing having an area designated and previously treated for adhering to the attachment surface of the one or more labels.

22. The system of claim 16, further comprising a posting wall having areas designated for each individual from the plurality of individuals, wherein the attachment surfaces of one or more of the one or more labels, the one or more tags, or the one or more notes are attachable to the posting wall.
